(19) United States
(12) Patent Application Publication
(10) Pub. No.: US 2015/0378714 A1
(43) Pub. Date: Dec. 31, 2015

(54) Providing Context-Specific Software Updates to Client Applications

(71) Applicant: Adobe Systems Incorporated, San Jose, CA (US)

(72) Inventors: Saransh Katariya, Indore (Madhya Pradesh) (IN); Mansukh Patidar, Greater Noida (IN); Ashish Mehta, Delhi (IN)

(73) Assignee: Adobe Systems Incorporated

(21) Appl. No.: 14/318,802

(22) Filed: Jun. 30, 2014

(51) Int. Cl. G06F 9/445; H04L 29/08; H04L 29/06

(52) U.S. Cl. CPC G06F 8/65; H04L 67/42; H04L 67/10

(57) ABSTRACT

In some embodiments, an update server receives an update request for an instance of a client application executed at a computing system. The update request includes context data describing an attribute of the computing system. If an update for the client application modifies a feature of the instance of client application associated with the described attribute, the update server provides the update to the computing system. The update server also receives an update request for an additional instance of the client application executed at another computing system. The additional update request includes context data describing an attribute of the additional computing system. If an available update modifies a feature of the additional instance of the client application that is associated with the described attribute, the update server provides the update to the additional computing system. If not, the update server notifies the additional computing system that no updates are available.

### TECHNICAL FIELD

This disclosure relates generally to computer-implemented methods and systems and more particularly relates to providing context-specific software updates to client applications.

### BACKGROUND

Software users can download or otherwise obtain software via online resources such as e-commerce websites, online application stores, etc. These online resources can facilitate software customization such that different versions of a given application can be customized to specific device and/or user configurations (e.g., a specific operating system, a specific device type, a specific user subscription, etc.). These online resources can also allow software updates (e.g., bug fixes, additional features, etc.) to be provided to users more frequently and can allow developers of software updates to target specific issues (e.g., fixes or improvements related to specific configurations).

Prior solutions for providing software updates can use software version numbers to determine whether to notify a user that an update is available. For example, an initial release of an application can be associated with a first version number (e.g., “1.0”), and an update to the application can be associated with an incremented version number (e.g., “1.1”). A service that provides software updates for the application to client devices can compare a version number of an instance of the application that is installed on a client device with a version number of an application version that is available from an online source (e.g., a product website). If the version number for the online application is higher than the version number for the installed instance of the application, the service can notify the client device that an update is available. A user of the client device can download the new version and update the installed instance of the application.

A disadvantage of prior solutions for requesting software updates is that these solutions may involve sending unwanted notifications to users by failing to account for system configurations of the users' client devices. For example, a software update may be posted that resolves a problem or provides new functions that are specific to a given client device configuration. However, all users may receive the update notification, even if the users have installed the software on client devices with configurations different from the given client device configuration. For frequently updated software applications, this solution may involve sending a large number of unwanted notifications for inapplicable updates.

Another disadvantage of prior solutions for requesting software updates is that these solutions may involve inefficient use of network bandwidth by providing updates to client devices that provide no value to those client devices. For example, a software update may resolve a problem that is specific to a given device manufacturer and that is not a problem for other device manufacturers. Users of devices from the other device manufacturers may be notified that the device-specific software update is available. These users of devices from the other device manufacturers may select and download the software update even though the software update provides no benefit for devices from the other device manufacturers. These downloads may unnecessarily consume network bandwidth by transmitting the software update to devices that do not benefit from the software update.

It is therefore desirable for software updates to be provided in a manner that accounts for contextual data associated with one or more of a target device configuration and a user of the target device.

### SUMMARY

According to certain embodiments, computing devices can provide context-specific software updates to client applications. In some embodiments, an update server can receive an update request for an instance of a client application executed at a first computing system. The update request includes context data describing an attribute of the first computing system. The attribute of the computing system described by the context data is independent of the client application. The update server provides an update for the client application to the first computing system based on determining that the update modifies a feature of the client application associated with the attribute described by the context data. The update server also receives a second update request that is for an additional instance of the client application executed at a second computing system. The second update request includes context data describing an attribute of the second computing system that is independent of the client application. If an available update for the second instance of the client application modifies a feature of the client application associated with the described attribute, the update server can provide the update to the second computing system. If not, the update server can notify the second computing system that no applicable updates are available.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings, where:

FIG. 1 is a block diagram depicting an example of a system for providing context-specific software updates to client applications according to certain exemplary embodiments;

FIG. 2 is a flow chart illustrating an example of a method for providing context-specific software updates to client applications according to certain exemplary embodiments;

FIG. 3 is a flow chart illustrating an additional example of a method for providing context-specific software updates to client applications according to certain exemplary embodiments;

FIG. 4 is a flow chart illustrating an example of a method for using context data to determine whether an update is available for a given computing system that executes an instance of a client application according to certain exemplary embodiments;

FIG. 5 is a flow chart illustrating another example of a method for using context data to determine whether an update is available for a given computing system that executes an instance of a client application according to certain exemplary embodiments;

FIG. 6 is a flow chart illustrating an example of a method for providing context-specific software updates that can be transmitted to client applications according to certain exemplary embodiments;

FIGS. 7A and 7B are diagrams depicting an example of an update description that includes context data about a software update according to certain exemplary embodiments;

FIG. 8 is a diagram depicting an example of an update request for a context-specific software update according to certain exemplary embodiments; and

FIG. 9 is a block diagram depicting an example of an implementation of an update server system according to certain exemplary embodiments.

### DETAILED DESCRIPTION

Computer-implemented systems and methods are disclosed for providing context-specific software updates to client applications. An update server system that provides software updates for one or more client applications can use client context data (e.g., information about a device at which the application is installed), user context data (e.g., information about a user of the application), or other suitable context data to determine whether a particular software update improves, fixes, or otherwise modifies features associated with a particular device configuration. The update server system notifies a target device that a particular software update is available if the software update is applicable to the specific configuration for the target device. If not, the update server does not notify the target device about the software update. Thus, the target device may receive notifications for applicable software updates without receiving unnecessary notifications about inapplicable software updates.

The following non-limiting example is provided to help introduce the general subject matter of certain embodiments. An update server system can implement an update service that identifies specific configurations of target devices to which a particular software update may apply. The configuration of a target device can include multiple characteristics about the device, such as (but not limited to) a device type or other hardware attributes for the device, a type or version of an operating system used by the device, a language used by the device to interact with users (e.g., Spanish, English, etc.), settings or other features related to the geographic location of the device (e.g., legal requirements for software in a given country), etc. In response to a request from a target device to check for updates, the update service can use descriptions of available software updates to identify whether a particular update applies to a particular configuration of the requesting target device. For example, each software update can be associated with an Extensible Markup Language (“XML”) file that identifies specific device configurations to which the update applies. A first software update may be associated with a first XML file that identifies a tablet computer with a first type of operating system, and a second software update may be associated with a second XML file that identifies a laptop computer with a second type of operating system. If the requesting target device identifies itself as a tablet computer with a first type of operating system (or the update service otherwise identifies this configuration for the target device), the update service provides a notification to the target device indicating that the first software update is available rather than the second software update, which is inapplicable to the target device configuration. This process can avoid sending notifications about the inapplicable second software update to the target device. This process can also optimize the use of network resources by preventing the target device from unnecessarily downloading an inapplicable update.

As used herein, the term “update server system” is used to refer to a server system that can access a database or other suitable data structure in which updates to software programs are stored or in which information that can be used to access these updates is stored. An update server system can manage updates, download updates, check for updates, etc.

As used herein, the term “client application” is used to refer to any application or other software program that can be used to display, execute, or otherwise use electronic content.

As used herein, the term “user context data” is used to refer to information about a user or other entity that can access a client application. Non-limiting examples of user context data include a user name, a legal name, an email address or other contact information, an access token, etc.

As used herein, the term “client context data” is used to refer to information about a computing system at which a client application is executed. In some embodiments, client context data can include software attributes (e.g., an operating system of the computing system, a human readable language used by one or more features of the client application, geographic location settings for the client application or the computing system, etc.). In additional or alternative embodiments, client context data can include hardware attributes (e.g., a device type for the computing system, etc.). In additional or alternative embodiments, client context data can include subscription information (e.g., some bug fix for perpetual users/subscription users but not for trial app).

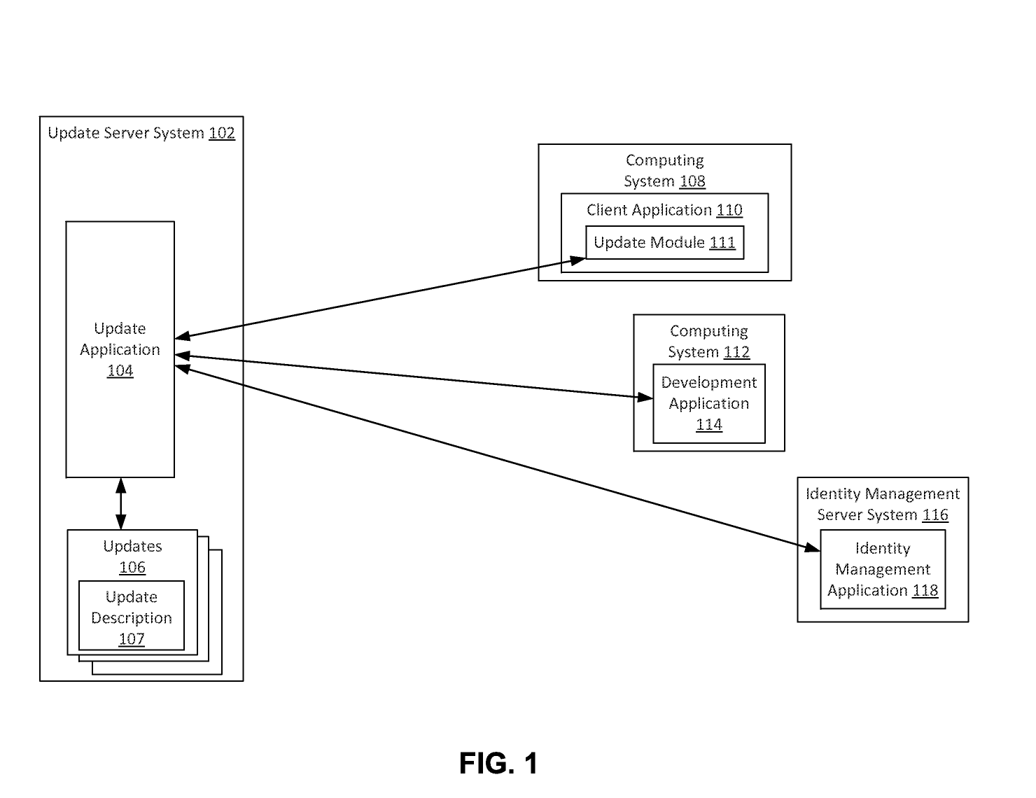

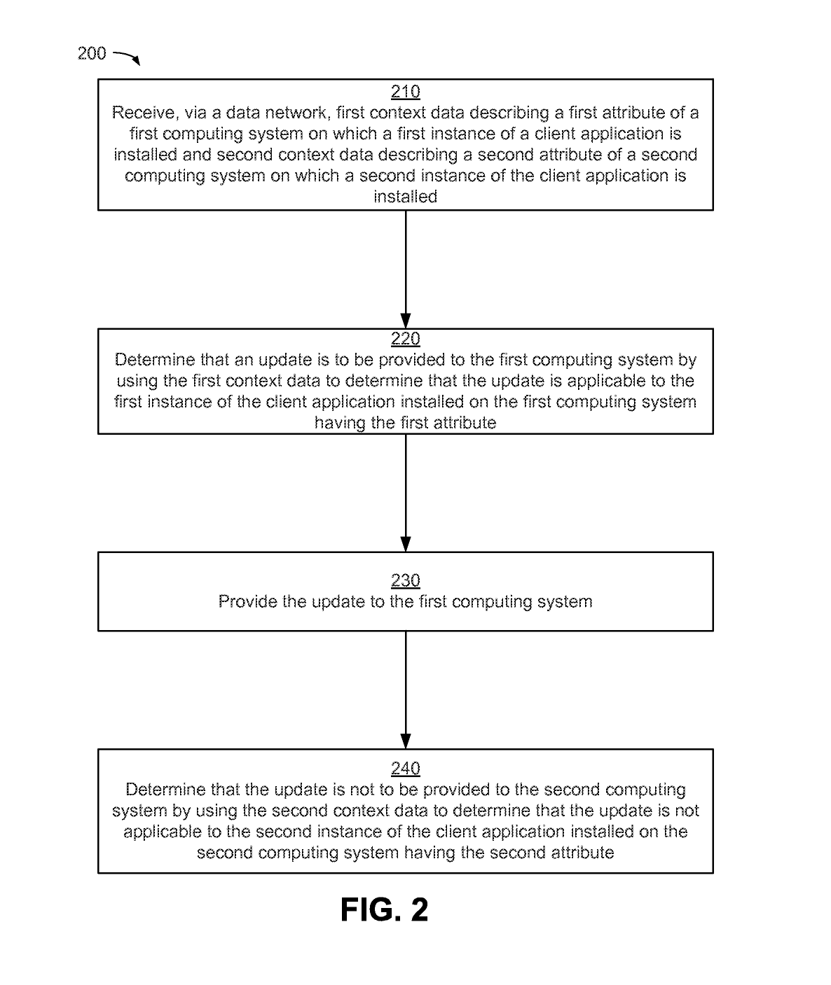

Referring now to the drawings, FIG. 1 is a block diagram depicting an example of a system for providing context-specific software updates to client applications. The system depicted in FIG. 1 includes an update server system 102 that can execute an update application 104 to provide updates 106 (or notifications about the updates 106) via a data network to a computing system 108 executing an instance of a client application 110. Examples of how the update server system 102 can facilitate the provision of updates 106 to the computing system 108 are described in detail with respect to FIGS. 2-5 herein.

Although FIG. 1 depicts a single update server system 102 for illustrative purposes, other implementations are possible. For example, multiple computing systems that are configured for grid-based computing or cloud computing can be used to implement the update server system 102.

Each of the updates 106 can include executable program code or other software for modifying one or more features of a client application 110. In some embodiments, the features of a client application 110 modified by the updates 106 can be features that are visible to or useable by an end user of the computing system 108. For example, a client application 110 may be modified by an update 106 to include new functions performed by the client application 110, corrections to bugs or other errors in the functions performed by the client application 110, etc. In additional or alternative embodiments, the features of a client application 110 that are modified by the updates 106 can include background features that affect how the computing system 108 executes or otherwise uses the client application 110 (e.g., new drivers for communicating with input or output device, changes to how the client application uses memory or other processing resources of the computing system 108, etc.).

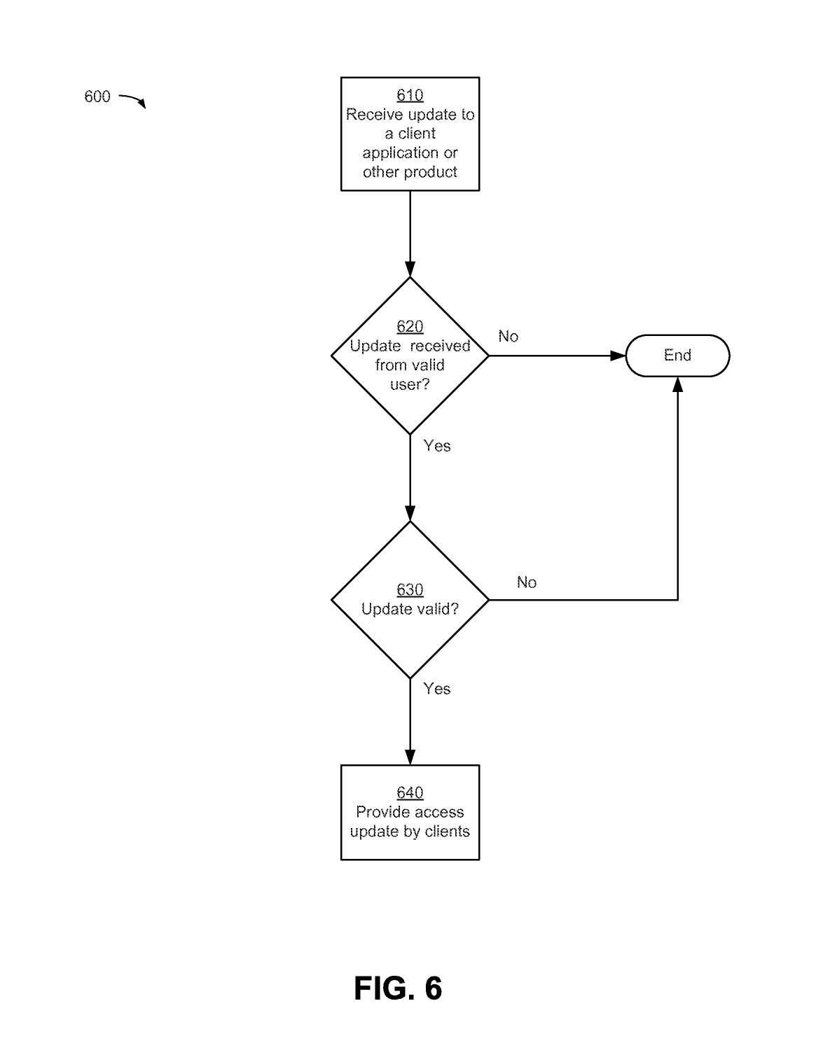

Each of the updates 106 can be associated with a respective update description 107. An update description 107 can be an XML file or other suitable file type that can be parsed or otherwise read by a processing device of the update server system 102. The update description 107 can include one or more details about a respective one of the updates 106 (e.g., which hardware or software attributes are affected by the update 106). The update server system 102 can use the update description 107 to determine whether a given one of the updates 106 is applicable to a specific configuration of a given computing system 108, as described in detail with respect to FIGS. 2-5 herein. In some embodiments, an update description 107 can be generated by a developer of a given update 106 using a development application, as described in detail with respect to FIG. 6 herein.

Although FIG. 1 depicts a single computing system 108 executing a single client application 110 for illustrative purposes, other implementations are possible. For example, each of multiple computing systems 108 can execute one or more different client applications 110 for which updates 106 can be received from the update server system 102. Different computing systems 108 can also execute different instances of the client application 110 that are specific to the system configurations of the different computing systems 108. The different instances of the client application 110 that are executed on the different computing systems 108 can provide the same end-user functionality (e.g., the same or similar interfaces for soliciting input or displaying output, similar program code for performing algorithms that use the input or generate the output, etc.). However, the different instances of the client application 110 may also include different program code that accounts for hardware or software features specific to a given computing system 108 to provide this end-user functionality. For example, a first computing system 108 may execute an instance of the client application 110 that includes program code for using specific input or output devices of the first computing system 108 (e.g., device drivers for using devices from a particular manufacturer), accessing a specific operating system of the first computing system 108 (e.g., different application programming interfaces), etc. A second computing system 108 may execute a different instance of the client application 110 that includes different program code for using specific input or output devices of the second computing system 108, accessing a specific operating system of the second computing system 108, etc.

The update application 104 can communicate with an update module 111 of the client application 110 to provide one or more of the updates 106 from the update server system 102 to the computing system 108. For example, the update module 111 can send update requests to the update application 104 that cause the update application 104 to check for updates. The update module 111 can also receive notifications from the update application 104 that cause the update module 111 to download updates from the update server system 102 or another source (e.g., a product website from which the client application 110 was downloaded). Although FIG. 1 depicts an update module 111 that is included in a client application 110, other implementations are possible. For example, the update module 111 may be included in an application separate from one or more client applications 110 and may be used to obtain updates for different client applications 110 executed on a given computing system 108 (e.g., client applications 110 from different software providers).

One or more additional computing systems 112 can communicate with the update server system 102 via a data network to provide one or more of the updates 106 to the update server system 102. A development application 114 executed at a computing system 112 can generate one or more of the updates 106. The development application 114 can communicate with the update application 104 to provide one or more of the updates 106 from the computing system 112 to the update server system 102. Examples of how updates 106 can be provided from the development application 114 to the update application 104 are provided herein with respect to FIG. 6.

Although FIG. 1 depicts a development application 114 in communication with the update application 104, other implementations are possible. For example, a development application 114 can be used to develop one or more updates 106 and provide the updates 106 to a separate application executed on the computing system 112. The separate application can communicate with the update application 104 to provide the updates 106 from the computing system 112 to the update server system 102.

In some embodiments, the update server system 102 can also communicate with an identity management server system 116 that executes an identity management application 118. The identity management server system 116 can be a server system or other computing system that can execute one or more identity management applications 118 for managing identity information. In one non-limiting example, the identity management application 118 can authenticate users of computing systems 108 that request updates 106 from the update server system 102. In another non-limiting example, the identity management application 118 can authenticate users of computing systems 112 that provide updates 106 to the update server system 102, etc. In some embodiments, the identity management server system 116 can provide interfaces to access tokens that can be used to authenticate requests received from client applications 110, development applications 114, or other applications against authentication credentials that are stored at and/or accessible by the identity management server system 116.

Although FIG. 1 depicts the update server system 102 and the identity management server system 116 as separate systems, other implementations are possible. For example, an update application 104 can perform one or more functions of the identity management application 118. In some embodiments, the same identity management server system 116 can be used to authenticate both users of client applications 110 and users of development applications 114. In other embodiments, one identity management server system 116 can be used to authenticate users of client applications 110 and a different identity management server system 116 can be used to authenticate users of development applications 114.

FIG. 2 is a flow chart illustrating an example of a method 200 for providing context-specific software updates to client applications. For illustrative purposes, the method 200 is described with reference to the implementation depicted in FIG. 1. Other implementations, however, are possible.

The method 200 involves receiving, via a data network, first context data describing a first attribute of a first computing system on which a first instance of a client application is installed and second context data describing a second attribute of a second computing system on which a second instance of the client application is installed, as depicted in block 210. For example, the update server system 102 can execute an update application 104 to receive first context data and second context data over a suitable data network from a first computing system 108 that executes a first client application 110. The first context data can include context data describing an attribute of the first computing system. The second context data can include context data describing an attribute of the second computing system. The described attributes of the first and second computing systems can be independent of the client application 110. The first and second context data can include one or more function calls that cause the update server system 102 to determine whether any of the available updates 106 are applicable to the configuration for the computing systems 108 and/or users of the computing systems 108.

In some embodiments, the attribute of a computing system 108 can be a hardware attribute. Non-limiting examples of hardware attributes include a manufacturer or product type of the computing system 108, a manufacturer or product type of one or more components of the computing system 108 used by the client application 110 (e.g., a type of output device, a type of input device, a type of processing device, an amount of available memory), attributes related to a processing device of the computing system 108, attributes related to memory available to the computing system 108, attributes related to a display type (e.g., touchscreen enabled, keyboard only, etc.), a device type (e.g., laptop, desktop, tablet, smart phone, etc.), or any other attribute related to hardware of the computing system 108.

In additional or alternative embodiments, the attribute of a computing system 108 can be a programming attribute or other software attribute. Non-limiting examples of programming attributes include a type or version of the operating system executed at the computing system 108, a human-readable language used for receiving input or displaying at the computing system 108 (i.e., whether menus and other interfaces display words and phrases in English, Japanese, or other languages), one or more setting related to a geographical location of the computing system 108, etc.

The method 200 also involves determining that an update is to be provided to the first computing system by using the first context data to determine that the update is applicable to the first instance of the client application installed on the first computing system having the first attribute, as depicted in block 220. For example, the update server system 102 can execute an update application 104 to determine that one of the updates 106 modifies a feature associated with the attribute described by the first context data. In some embodiments, the update application 104 can retrieve or otherwise obtain the update 106 from a database or other suitable data structure stored in a non-transitory computer-readable medium that is included in or accessible by the update server system 102. The update application 104 can transmit or otherwise provide the obtained update 106 via the data network to an update module 111 executed at the first computing system 108. In additional or alternative embodiments, the update application 104 can retrieve or otherwise obtain an update description 107 associated with the update 106 from a database or other suitable data structure stored in a non-transitory computer-readable medium that is included in or accessible by the update server system 102. The update application 104 can transmit or otherwise provide a notification via the data network to an update module 111. The notification can include information from the update description 107 that indicates how to retrieve the update 106 (e.g., a network address from which the update 106 can be downloaded).

In some embodiments, the update application 104 can determine that the update modifies a feature associated with the attribute described by the first context data by comparing the first context data with an update description 107 for a given update 106. For example, an update description 107 may list one or more attributes of an associated update 106 and respective values for those attributes. The update application 104 can retrieve or otherwise obtain the update description 107 from a database or other suitable data structure stored in a non-transitory computer-readable medium that is included in or accessible by the update server system 102. The update application 104 can determine whether a value of the attribute that is described by (or otherwise identifiable from) the received context data is equal to (or otherwise corresponds) to a value of the attribute that is described by (or otherwise identifiable from) the obtained update description 107. The update application 104 can determine that the update modifies a feature associated with the attribute based on a match or other correspondence between the values of the attribute from the received context data and the obtained update description 107.

In a non-limiting example, a computing system 108 may be a tablet computer that uses an operating system “OS1” and that executes a client application 110 such as “Product X” with a version “1.0.0.” The OS1 operating system may include settings indicating that the computing system 108 is being used in India and that the English language is to be used for receiving inputs and providing outputs. The update server system 102 may have a version “1.0.4” of Product X. The computing system 108 can transmit an context data to the update server system 102 that causes the update server system 102 to check for updates to the Product X that are applicable to the specific configuration of the computing system 108. The update server system 102 can read the update descriptions 107 to identify the latest update to the Product X that is applicable for the configuration of the computing system 108 (e.g., a tablet computer running the OS1 operating system and configured for English language use in India). If there is an update 106 that is applicable to this configuration, the update server system 102 can transmit an electronic communication with an update notification via a data network to the update module 111 executed on the computing system 108. The update module 111 can respond to the update notification by downloading the update 106 and installing the update 106. In some embodiments, the update module 111 can download the update 106 from the update server system 102. In other embodiments, a notification transmitted to the update module 111 can include a network address (e.g., a hyperlink) to another network resource from which the update module 111 can download the update 106.

The method 200 also involves providing the update for the first instance of the client application to the first computing system, as depicted in block 230. For example, the update server system 102 can execute an update application 104 to transmit or otherwise provide the obtained update 106 via the data network to an update module 111 executed at the first computing system 108. In additional or alternative embodiments, the update application 104 can retrieve or otherwise obtain an update description 107 associated with the update 106 from a database or other suitable data structure stored in a non-transitory computer-readable medium that is included in or accessible by the update server system 102. The update application 104 can transmit or otherwise provide a notification via the data network to an update module 111. The notification can include information from the update description 107 that indicates how to retrieve the update 106 (e.g., a network address from which the update 106 can be downloaded).

The method 200 also involves determining that the update is not to be provided to the second computing system by using the second context data to determine that the update is not applicable to the second instance of the client application installed on the second computing system having the second attribute, as depicted in block 240. For example, the update server system 102 can execute an update application 104 to determine whether the update modifies a feature associated with the attribute described by the second context data in a manner similar to the description above with respect to block 220. If the second update does not modify a feature associated with the attribute described by the second context data, the update application 104 can generate a message that no applicable updates are available. The update server system 102 can transmit an electronic communication that includes the message via a data network to the second computing system 108 or another computing device associated with a user of the second computing system 108.

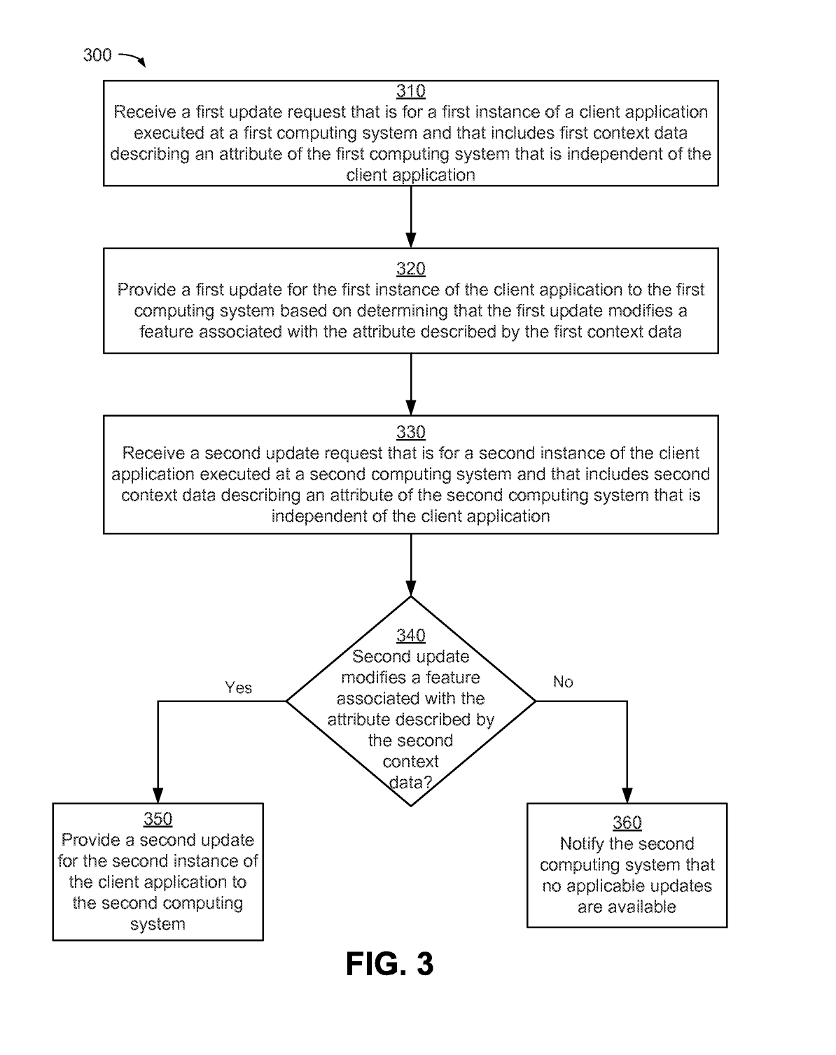

FIG. 3 is a flow chart illustrating an additional example of a method 300 for providing context-specific software updates to client applications. For illustrative purposes, the method 300 is described with reference to the implementation depicted in FIG. 1. Other implementations, however, are possible. Any of the operations in FIG. 3 can be used in combination with, in addition to, or as an alternative to one or more operations described above with respect to the method 200 depicted in FIG. 2.

The method 300 involves receiving a first update request that is for a first instance of a client application executed at a first computing system, as depicted in block 310. For example, the update server system 102 can execute an update application 104 to receive a first update request over a suitable data network from a first computing system 108 that executes a first client application 110. The first update request can include context data describing an attribute of the first computing system that is independent of the client application 110. The update request can include one or more function calls that cause the update server system 102 to determine whether any of the available updates 106 are applicable to the configuration for the computing system 108 and/or a user of the computing system 108.

In some embodiments, the attribute of the computing system 108 can be a hardware attribute, as described above with respect to FIG. 2. In additional or alternative embodiments, the attribute of the computing system 108 can be a programming attribute or other software attribute, as described above with respect to FIG. 2.

The method 300 also involves providing a first update for the first instance of the client application to the first computing system based on determining that the first update modifies a feature associated with the attribute described by the first context data, as depicted in block 320. For example, the update server system 102 can execute an update application 104 to determine that a first one of the updates 106 modifies a feature associated with the attribute described by the first context data. In some embodiments, the update application 104 can retrieve or otherwise obtain the first update 106 from a database or other suitable data structure stored in a non-transitory computer-readable medium that is included in or accessible by the update server system 102. The update application 104 can transmit or otherwise provide the obtained update 106 via the data network to an update module 111 executed at the first computing system 108. In additional or alternative embodiments, the update application 104 can retrieve or otherwise obtain an update description 107 associated with the first update 106 from a database or other suitable data structure stored in a non-transitory computer-readable medium that is included in or accessible by the update server system 102. The update application 104 can transmit or otherwise provide a notification via the data network to an update module 111. The notification can include information from the update description 107 that indicates how to retrieve the update 106 (e.g., a network address from which the update 106 can be downloaded).

In some embodiments, the update application 104 can determine that the first update modifies a feature associated with the attribute described by the first context data by comparing the first context data with an update description 107 for a given update 106, as described above with respect to FIG. 2. For example, an update description 107 may list one or more attributes of an associated update 106 and respective values for those attributes. The update application 104 can retrieve or otherwise obtain the update description 107 from a database or other suitable data structure stored in a non-transitory computer-readable medium that is included in or accessible by the update server system 102. The update application 104 can determine whether a value of the attribute that is described by (or otherwise identifiable from) the received context data is equal to (or otherwise corresponds) to a value of the attribute that is described by (or otherwise identifiable from) the obtained update description 107. The update application 104 can determine that the first update modifies a feature associated with the attribute based on a match or other correspondence between the values of the attribute from the received context data and the obtained update description 107.

In a non-limiting example, a computing system 108 may be a tablet computer that uses an operating system “OS1” and that executes a client application 110 such as “Product X” with a version “1.0.0.” The OS1 operating system may include settings indicating that the computing system 108 is being used in India and that the English language is to be used for receiving inputs and providing outputs. The update server system 102 may have a version “1.0.4” of Product X. The computing system 108 can transmit an update request to the update server system 102 that causes the update server system 102 to check for updates to the Product X that are applicable to the specific configuration of the computing system 108. The update server system 102 can read the update descriptions 107 to identify the latest update to the Product X that is applicable for the configuration of the computing system 108 (e.g., a tablet computer running the OS1 operating system and configured for English language use in India). If there is an update 106 that is applicable to this configuration, the update server system 102 can transmit an electronic communication with an update notification via a data network to the update module 111 executed on the computing system 108. The update module 111 can respond to the update notification by downloading the update 106 and installing the update 106. In some embodiments, the update module 111 can download the update 106 from the update server system 102. In other embodiments, a notification transmitted to the update module 111 can include a network address (e.g., a hyperlink) to another network resource from which the update module 111 can download the update 106.

The method 300 also involves receiving a second update request that is for a second instance of the client application executed at a second computing system and that includes context data describing an attribute of the second computing system that is independent of the client application, as depicted in block 330. For example, the update server system 102 can execute the update application 104 to receive a second update request over a suitable data network from a second computing system 108 that executes a second client application 110 in a manner similar to the description above with respect to block 310.

The method 300 also involves determining whether the second update modifies a feature associated with the attribute described by the second context data, as depicted in block 340. For example, the update server system 102 can execute an update application 104 to determine whether the second update modifies the feature associated with the attribute described by the second context data in a manner similar to the description above with respect to block 320.

If the second update modifies a feature associated with the attribute described by the second context data, the method 300 also involves providing a second update for the second instance of the client application 110 to the second computing system, as depicted in block 350. For example, the update server system 102 can execute an update application 104 to determine that a second one of the updates 106 modifies a feature associated with the attribute described by the second context data. In some embodiments, the update application 104 can retrieve or otherwise obtain the second update 106 from a database or other suitable data structure stored in a non-transitory computer-readable medium that is included in or accessible by the update server system 102. The update application 104 can transmit or otherwise provide the obtained update 106 via the data network to an update module 111 executed at the second computing system 108. In additional or alternative embodiments, the update application 104 can retrieve or otherwise obtain an update description 107 associated with the second update 106 from a database or other suitable data structure stored in a non-transitory computer-readable medium that is included in or accessible by the update server system 102. The update application 104 can transmit or otherwise provide a notification via the data network to an update module 111. The notification can include information from the update description 107 that indicates how to retrieve the update 106 (e.g., a network address from which the update 106 can be downloaded).

In a non-limiting example, a computing system 108 may be a laptop computer using an operating system “OS2” and executing a client application 110 such as “Product X” with a version “1.0.0.” The OS2 operating system may include settings indicating that the computing system 108 is being used in China and that the Mandarin language is to be used for receiving inputs and providing outputs. The update server system 102 may have a version “1.0.4” of Product X. The computing system 108 can transmit an update request to the update server system 102 that causes the update server system 102 to check for updates to the Product X that are applicable to the specific configuration of the computing system 108. The update server system 102 can read the update descriptions 107 to identify the latest update to the Product X that is applicable for the configuration of the computing system 108 (e.g., a laptop computer running the OS2 operating system and configured for Mandarin language use in China). If there is an update 106 that is applicable to this configuration, the update server system 102 can transmit an electronic communication with an update notification via a data network to the update module 111 executed on the computing system 108. The update module 111 can respond to the update notification by downloading the update 106 and installing the update 106.

If the second update does not modify a feature associated with the attribute described by the second context data, the method 300 also involves notifying the second computing system that no applicable updates are available, as depicted in block 360. For example, the update server system 102 can execute an update application 104 to generate a message that no applicable updates are available. The update server system 102 can transmit an electronic communication that includes the message via a data network to the computing system 108 or another computing device associated with a user of the computing system 108.

For example, the computing system 108 may be the laptop computer executing the Product X and the operating system OS3. The computing system 108 can transmit an update request to the update server system 102 that causes the update server system 102 to check for updates to the Product X that are applicable to the specific configuration of the computing system 108. The update server system 102 can read the update descriptions 107 to identify the latest update to the Product X that is applicable for the configuration of the computing system 108 (e.g., a laptop computer running the OS3 operating system). The update server system 102 can determine that none of the updates 106 includes update descriptions 107 that identify the OS3 operating system. The update server system 102 can transmit an electronic communication via a data network to the update module 111 executed on the computing system 108. The electronic communication can notify the update module 111 that no applicable updates are available that correspond to the context data provided in the update request.

In additional or alternative embodiments, the update server system 102 can also provide updates 106 for a given instance of a client application 110 based on a subscription type for the instance of a client application 110. For example, the update server system 102 can receive an update request that includes context data describing a subscription attribute (e.g., paid, unpaid, trial, etc.) for an instance of the client application 110. The update server system 102 can determine whether the subscription attribute indicates that the instance of the client application 110 is a paid subscription version of the client application 110 or an unpaid subscription version of the client application 110. If the instance of the client application 110 is a paid subscription version of the client application 110, the update server system 102 can transmit an update 106 to the computing system 108 that updates features for the paid subscription version of the client application 110. If the instance of the client application 110 is an unpaid or other trial subscription version of the client application 110, the update server system 102 can transmit an update 106 to the computing system 108 that updates features for the unpaid subscription version of the client application 110 or can notify the computing system 108 that updates are not available for the unpaid subscription version of the client application 110.

In some embodiments, the update server system 102 can perform one or more operations that optimize or otherwise improve the method 300 based on specific business goals or other requirements. In some embodiments, if an update notification is provided to the computing system 108 and the corresponding update 106 is not downloaded by the computing system 108, the update system 102 may require the computing system 108 to download the update. For example, the update application 104 may notify one or more network resources that are used by the client application 110 that the computing system 108 is prohibited from using the client application 110 to access the network resources unless the computing system downloads and installs the update 106. In other embodiments, the update server system 102 may skip that update 106.

In additional or alternative embodiments, the update server system 102 may alert the computing system 108 or a user of the computing system 108 if the instance of the client application 110 installed on the computing system 108 is out of date. For example, the update server system 102 can store or otherwise maintain records of update histories for multiple client applications 110 executed on multiple computing systems 108. The records of update histories can be stored in one or more databases or other data sources that are accessible to the update server system 102. If the update server system 102 receives an update 106 and/or a corresponding update description 107 from a developer application 114, the update application 104 can retrieve records from the database or other data source that included data describing a configuration to which the received update 106 applies. In some embodiments, the update application 104 can transmit a notification to an update module 111 of an affected computing system 108 that the applicable update is available. In additional or alternative embodiments, the update application 104 can transmit a notification to an electronic address other than the computing system 108 that is associated with a user of the client application 110 or the computing system 108. For example, the update application 104 can transmit this notification in an e-mail to an e-mail address or as a text message to a phone number. The notification transmitted to the user can cause the user to access the update module 111 and send an update request from the update module 111. In additional or alternative embodiments, the update application 104 can transmit the update 106 to the update module 111 without sending a separate notification to the computing system 108 or other electronic address associated with a user of the client application 110 or the computing system 108.

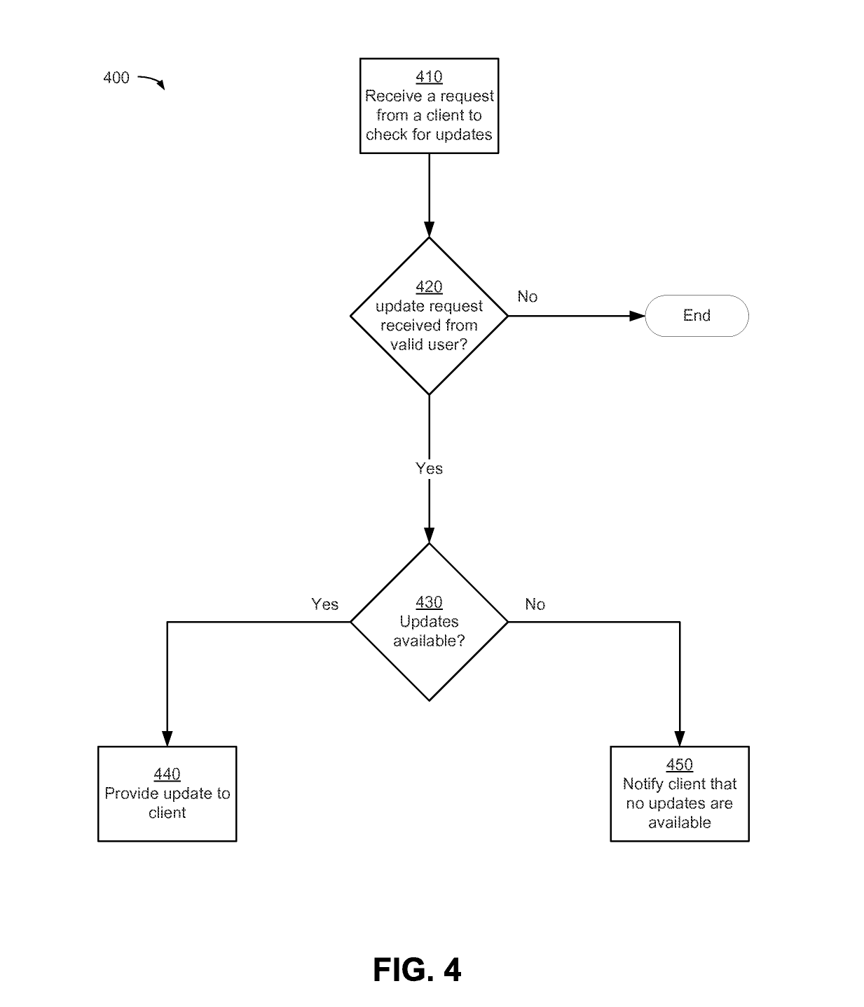

Any suitable process can be executed by a computing system 108 to determine if updates are available for an instance of a client application 110 executed at the computing system 108. For example, FIG. 4 is a flow chart illustrating an example of a method 400 for using context data to determine whether an update is available for a given computing system that executes an instance of a client application. For illustrative purposes, the method 400 is described with reference to the implementation depicted in FIG. 1. Other implementations, however, are possible.

The method 400 involves receiving a request to check for updates, as depicted in block 410. For example, the computing system 108 can execute an update module 111 to access a website or other network resource (e.g., an “Application Store” website) provided by an update server system 102 or other server system over a data network such as the Internet. The website or other network resource can generate a web page or other interface that can be used by a user of the computing system 108 to indicate that he or she wishes to check for updates. A non-limiting example of such an interface is a list of applications that are installed on the computing system 108, where a “Check for Updates” button is displayed next to each listed application. The update module 111 executed at the computing system 108 can receive input from the user indicating that the user wishes to receive updates for one or more of the client applications 110 (e.g., clicking a “check for updates” button). The update module 111 can identify one or more configuration parameters of the computing system 108 and/or an instance of the client application 110 executed at the computing system 108. The update module 111 can transmit the identified configuration parameters to the update server system 102 with a request to check for updates.

The method 400 also involves the update server system 102 determining whether the update request is received from a valid user, as depicted in block 420. For example, the update server system 102 can execute an update application 104 to request that the identity management server system 116 perform one or more functions for validating the user. The identity management server system 116 can execute the identity management application 118 to validate the user.

In one non-limiting example, the identity management application 118 can compare one or more authentication credentials received with the update request to one or more authentication credentials stored in a non-transitory computer-readable medium that is included in or accessible by the identity management server system 116. Non-limiting examples of authentication credentials can include one or more of a token, a user name, account number, password, passcode, etc. The identity management application 118 can validate the user based on a match or other correspondence between the received authentication credentials and the stored authentication credentials. If the update server system 102 does not determine that the update request is received from a valid user, the method 400 terminates.

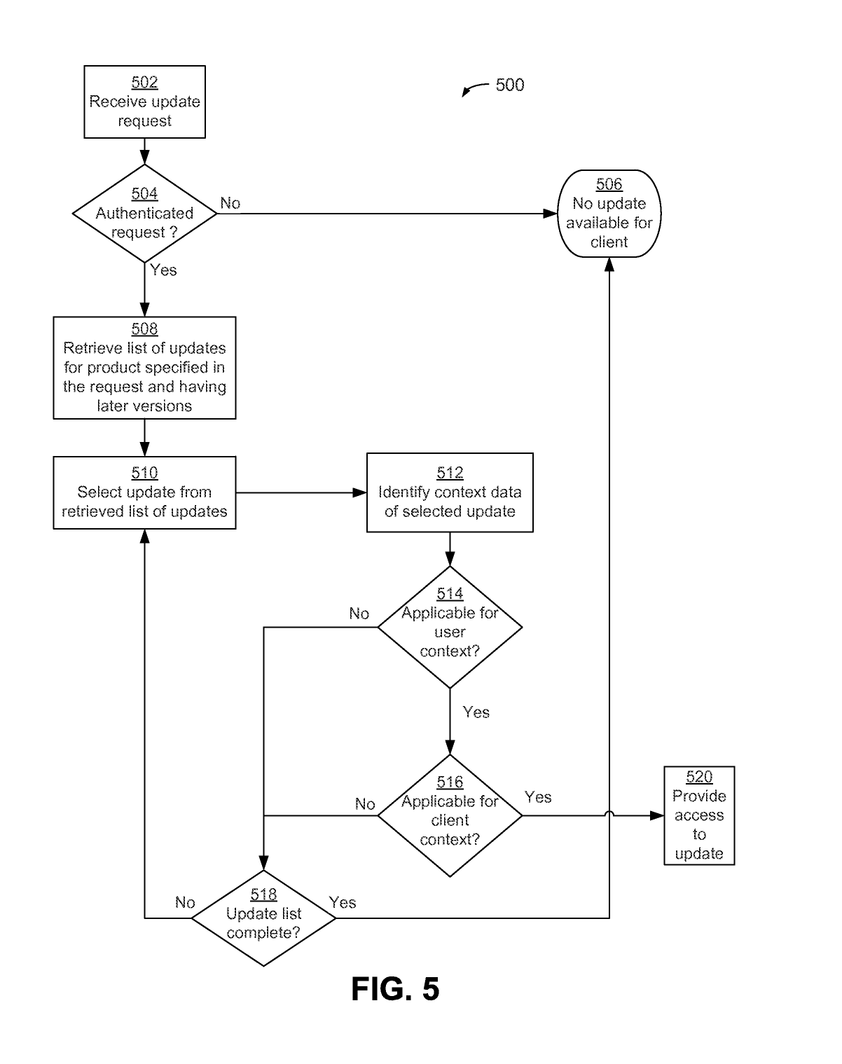

If the update server system 102 determines that the update request is received from a valid user, the method 400 also involves the update server system 102 determining whether any updates are available, as depicted in block 430. For example, the update server system 102 can execute an update application 104 to determine whether any updates are available that correspond to the configuration parameters identified by the update module 111. Details for determining whether any updates are available are provided herein with respect to FIG. 5.

The method 400 also involves the update server system 102 determining whether any updates are available, as depicted in block 430. For example, the update server system 102 can execute an update application 104 to determine whether any updates are available that correspond to the configuration parameters identified by the update module 111. If any updates are available, the update server system 102 can provide one or more available updates 106 to the computing system 108, as depicted at block 440 and described above with respect to block 320 of FIG. 3. If no updates are available, the update server system 102 can notify the computing system 108 that no updates are available, as depicted at block 450 and described above with respect to block 350 of FIG. 3.

Any suitable process can be used for determining whether any updates are available. For example, FIG. 5 is a flow chart illustrating an example of a method 500 for using context data to determine whether an update is available for a given computing system that executes an instance of a client application. For illustrative purposes, the method 500 is described with reference to the implementation depicted in FIG. 1. Other implementations, however, are possible.

The method 500 involves receiving an update request, as depicted in block 502. For example, the update server system 102 can execute an update application 104 to receive an update request from a computing system 108 at which at client application 110 is executed. The update request can be provided to the update server system 102 in a manner similar to the description above with respect to FIGS. 2-4.

The method 500 also involves authenticating a user or system from which the update request was received, as depicted in block 504. For example, the update server system 102 can execute an update application 104 to authenticate the update request. The update request can be authenticated in a manner similar to the description above with respect to block 420 of FIG. 4.

If the user or system from which the update request was received is not authenticated, the update server system 102 can notify the computing system 108 that no updates are available and the method 500 can end, as depicted at block 506. For example, the update server system 102 can transmit an electronic communication via a data network to the computing system 108 indicating that no updates are available.

If the user or system from which the update request was received is authenticated, the method 500 involves retrieving a list of updates for the product or other client application 110 specified in the update request and having later versions than the specified product or other client application 110, as depicted at block 508. For example, the update server system 102 can execute the update application 104 to retrieve or otherwise obtain the updates 106 from a database or other data source stored in a non-transitory computer-readable medium that is included in or accessible to the update server system 102. The update application 104 can retrieve or otherwise obtain the updates 106 having respective update descriptions 107 that identify version numbers of the client application 110 that are greater than the version number of the client application 110 installed at the computing system 108.

In some embodiments, the update application 104 can identify a version of the client application 110 executed at the computing system 108 from data included in the received update request. In other embodiments, the update application 104 can identify a version of the client application 110 executed at the computing system 108 by accessing a database or other data source that includes records describing update histories for computing systems at which the client application 110 is installed. The update application 104 can obtain an identifier for the computing system 108 from the received update request. The update application 104 can use the obtained identifier to retrieve a record of the update history for the computing system 108. The update application 104 can use the retrieved record to determine the highest version number of the client application 110 installed at the computing system 108.

The method 500 also involves selecting one of the retrieved updates, as depicted at block 510. For example, the update server system 102 can execute the update application 104 to select one of the retrieved updates having a version number higher than a version number of the instance of the client application 110 executed at the computing system 108.

The method 500 also involves identifying context data of the selected update, as depicted at block 512. The update server system 102 can execute the update application 104 to identify the context data of the selected version of the update. For example, the update application 104 can parse or otherwise read context data provided in an update description 107 associated with the selected update 106.

The context data can include one or both of user context data and client context data for the selected update 106. User context data can include information about a user or other entity that can access a client application 110 via a computing system 108. Non-limiting examples of user context data include a user name, a legal name, an email address or other contact information, an access token, etc. Client context data can include information about a computing system 108 at which a client application 110 is executed. In some embodiments, client context data can include software attributes, such as (but not limited to) an operating system of the computing system 108, a human readable language used by one or more features of the client application 110 or another application executed at the computing system 108, geographic location settings for the client application 110 or the computing system 108, etc. In additional or alternative embodiments, client context data can include hardware attributes, such as (but not limited to) a device type for the computing system 108, available processing resource for the computing system 108, etc. In additional or alternative embodiments, client context data can include subscription information (e.g., where some bug fixes are available for perpetual users or subscription users, but not for trial versions or unpaid subscription versions of the client application 110.)

The method 500 also involves determining whether the selected update is applicable for a user context identified in the update request, as depicted at block 514. For example, the update server system 102 can execute the update application 104 to compare the user context data from the update request to user context data from the update description 107 of the selected update 106. The update server system 102 can determine that the selected update is applicable if the user context data from the update request matches or otherwise corresponds to the user context data from the update description 107 of the selected update 106.

If the selected update is applicable for a user context identified in the update request, the method 500 also involves determining whether the selected update is applicable for a client context identified in the update request, as depicted at block 516. For example, the update server system 102 can execute the update application 104 to compare the client context data from the update request to client context data from the update description 107 of the selected update 106. The update server system 102 can determine that the selected update is applicable if the client context data from the client request matches or otherwise corresponds to the client context data from the update description 107 of the selected update 106.

If the selected update is not applicable for the user context and/or the selected update is not applicable for the client context, the method 500 also involves determining if the context data has been checked for each update from the list of available updates retrieved at block 508, as depicted at block 518. For example, for each update in the list, the update application 104 can delete or mark an identifier of the update after the update application 104 has checked the context data for that update. If the context data has not been checked for each version of the update from the list, the method 500 returns to block 510 and selects the next available update from the list. If the context data has been checked for each version of the update from the list, the method 500 proceeds to block 506 and ends.

If the selected update is applicable for both the user context and the client context, the method 500 also involves providing access to the selected update 106 to the computing system 108, as depicted at block 520. In some embodiments, the update server system 102 can execute the update application 104 to generate a notification that the selected update 106 is available and is applicable to a specific configuration of the computing system 108 executing an instance of the client application 110. The update server system 102 can transmit an electronic communication with the notification to the computing system 108 via a data network. The update module 111 executed at the computing system 108 can respond to the notification by downloading the selected update 106 from the update server system 102 or another server system via the data network. In other embodiments, the update server system 102 can transmit the selected update 106 to the computing system 108 without the computing system 108 having to download the update 106 after receiving a notification that the update 106 is available.

In some embodiments, the update server system 102 can execute one or more additional operations that optimize or otherwise improve the method 500 based on specific business goals or other requirements. In one non-limiting example, the update server system 102 can track which of the updates 106 is checked in response to an update request received by a particular computing system 108. For example, block 508 can involve the update server system 102 creating or modifying a record describing an update history of the computing system 108 to indicate that the list of updates retrieved in block 508 has been checked by the update server system 102. The update history record for the computing device 108 can include timestamps, version comparisons, or other data that identify which versions of an update 106 are retrieved at block 508 and checked at blocks 512, 514, 516. If the update server system 102 subsequently receives another update request from the computing system 108, the update server system 102 can exclude any previously checked updates from the list that is retrieved at block 508.

Any suitable process can be used by a development application 114 or other suitable application to upload or otherwise provide updates 106 to the update server system 102. For example, FIG. 6 is a flow chart illustrating an example of a method 600 for providing context-specific software updates that can be transmitted to client applications. For illustrative purposes, the method 600 is described with reference to the implementation depicted in FIG. 1. Other implementations, however, are possible.

The method 600 involves receiving an update 106 from a development application 114, as depicted in block 610. For example, the computing system 112 can execute a development application 114 to create, edit, or otherwise modify program code for one or more features of a client application 110. The computing system 112 can execute a development application 114 or other suitable application to access a website or other network resource (e.g., an “Application Store” website) provided by an update server system 102 over a data network such as the Internet. The website or other network resource can generate a web page or other interface that can be used by a user of the computing system 112 to indicate that he or she wishes to transmit an update to the update server system 102. The development application 114 or other suitable application executed at the computing system 112 can receive input to the interface from the user indicating that the user wishes to transmit an update 106 for one or more of the client applications 110. The development application 114 can retrieve the update 106 from a non-transitory computer-readable medium of the computing system 112 and transmit the update 106 to the update server system 102 via the data network.

The method 600 also involves the update server system 102 determining whether the update 106 is received from a valid user, as depicted in block 620. For example, the update server system 102 can execute an update application 104 to request that the identity management server system 116 perform one or more functions for validating the user and/or a computing system 112 from which an update 106 may be received. The identity management server system 116 can execute the identity management application 118 to validate the user or the computing system 112.

In one non-limiting example, the identity management application 118 can compare one or more authentication credentials received with the update 106 to one or more authentication credentials stored in a non-transitory computer-readable medium that is included in or accessible by the identity management server system 116. Non-limiting examples of authentication credentials can include one or more of a token, a user name, account number, password, passcode, etc. The identity management application 118 can validate the user based on a match or other correspondence between the received authentication credentials and the stored authentication credentials. If the update server system 102 does not determine that the update 106 is received from a valid user, the method 600 terminates.

If the update server system 102 determines that the update 106 is received from a valid user, the method 600 also involves the update server system 102 validating the received update 106, as depicted in block 630. For example, the update server system 102 can execute an update application 104 validate the received update 106. In some embodiments, validating the received update 106 can involve determining whether the received update 106 includes or is associated with an update description 107 having values for one or more required context parameters. For example, a list of required context parameters can include attributes of computing systems 108 that may be affected by updates 106 (e.g., operating system, device type, etc.). The update application 104 can validate a received update 106 by confirming that an update description 107 associated with the received update identifies each of the required context parameters in the list and has at least one value for each of the context parameters. In some embodiments, validating the received update 106 can also involve one or both of the update application 104 and the identity management application 118 determining that the update 106 received from a computing system 112 does not include any malicious program code.

If the received update 106 is valid, the method 600 also involves the update server system 102 providing access to the update 106 by one or more computing systems 108 executing the client application 110, as depicted in block 640. For example, the update server system 102 can execute an update application 104 to store the received update 106 in a database or other data structure from which the update application 104 provides updates 106 to computing systems 108 in the manner described in FIGS. 2-5. If the received update 106 is valid, the method 600 terminates.

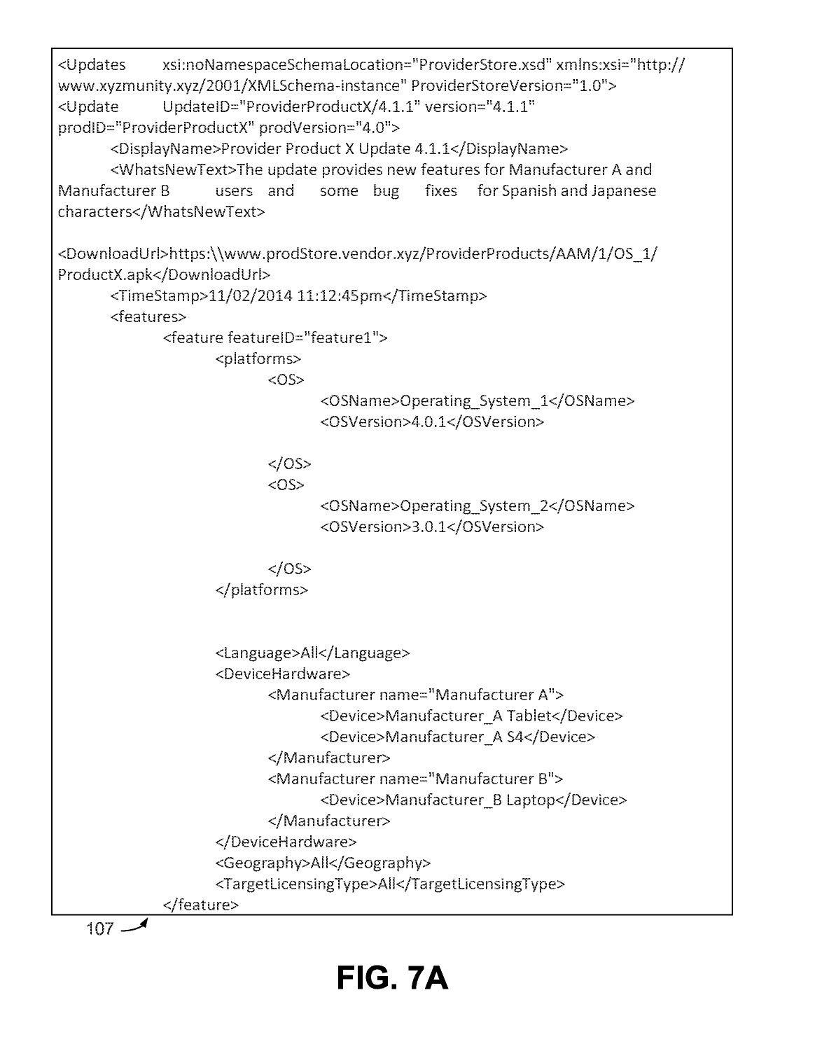

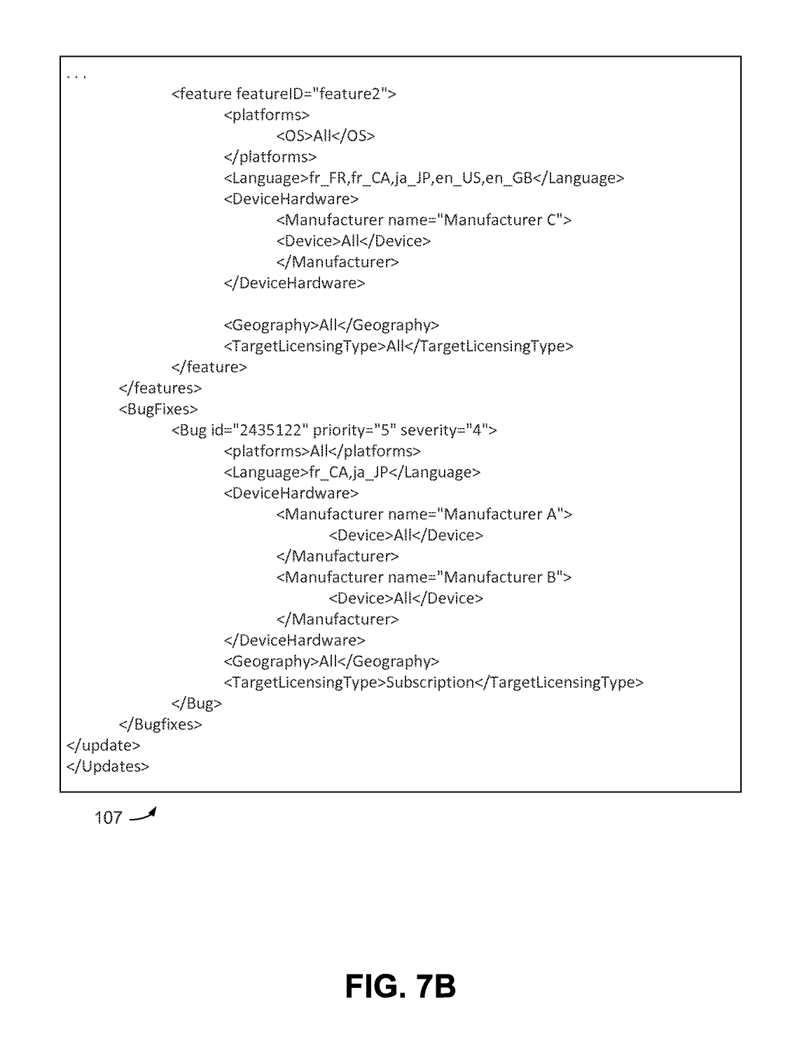

Any suitable file format can be used to provide update descriptions 107 to the update server system 102. For example, FIGS. 7A and 7B are diagrams depicting a non-limiting example of an update description 107 that includes context data about a software update 106. The update description 107 depicted in FIGS. 7A and 7B is an XML file. The update server system 102 can parse the XML file to determine specific configurations to which the update 106 applies.

The XML file can include one or more tags that identify one or more configurations to which the update 106 applies. As depicted in FIGS. 7A and 7B, these tags identify the update 106 (e.g., “UpdateID=‘ProviderProductX/4.1.1’”), the client application 110 (e.g., “prodID=‘ProviderProductX’”), and the applicable version of the client application 110 (e.g., “version=‘4.1.1’”). The XML file can also identify a network location from which the update 106 can be retrieved (e.g., “<DownloadUrl>https:\\www.prodStore.vendor.xyz/ProviderProducts/AAM/1/OS_{—}1/ProductX.apk </DownloadUrl>”). In some embodiments, the network location can be a resource hosted by the update server system 102. In additional or alternative embodiments, the network location can be a resource hosted by a server system independent from the update server system 102.

The XML file can also identify features of the client application 110 that are affected by the update 106. For example, FIG. 7A depicts tags for a first feature (e.g., “featureID=‘feature1’”) and FIG. 7B depicts tags for a second feature (e.g., “featureID=‘feature2’”). The XML file depicted in FIGS. 7A and 7B also includes tags describing applicable platforms for the update 106 (e.g., “<OSName>”, “<OSVersion>”), applicable human-readable languages for the update 106 (e.g. “<Language>”), applicable hardware attributes for the update 106 (e.g. “<Manufacturer Name>”, “<Device>”), applicable location settings for the update 106 (e.g. “<Geography>”), and applicable subscription attributes for the update 106 (e.g. “<TargetLicensingType>”).

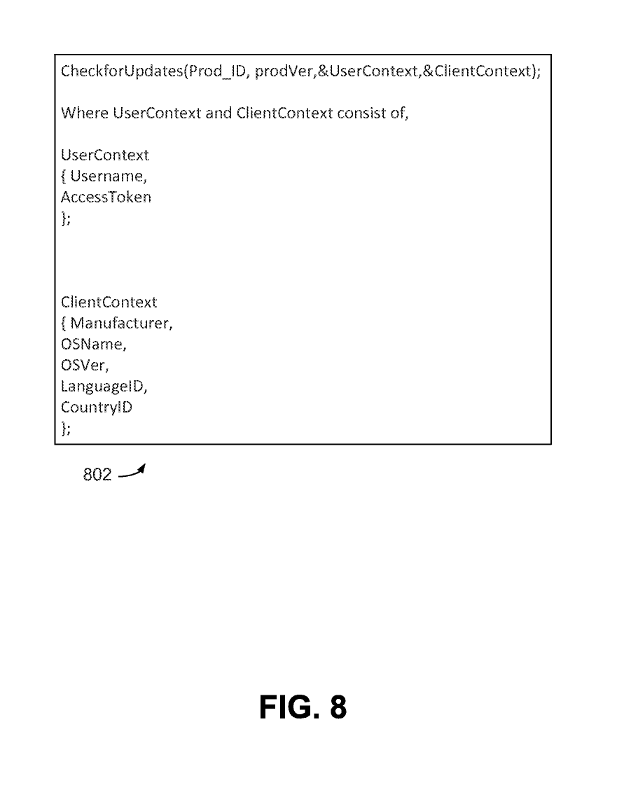

Any suitable update request can be used by the computing system 108. For example, FIG. 8 is a diagram depicting an example of an update request 802 for a context-specific software update. The update request 802 depicted in FIG. 8 is an XML file. The XML file can include one or more tags that can be used by the update server system 102 to identify a specific configuration of the computing system 108 executing an instance of the client application 110.

For example, the tags depicted in FIG. 8 include a “Product_ID” tag that identifies the client application 110. The tags also include a “ProductVer” tag that identifies the version of the client application 110 for which the update server system 102 is to check for updates. The tags also include a “username” identifying a user of the client application 110. The tags also include an “AccessToken” tag that can include an access token (e.g., an alphanumeric string) granted by the identity management server system 116. The access token allows the update server system 102 to validate or otherwise authenticate the update request 802. In some embodiments, the access tokens may have a specific authorization scope and a specific duration in which the access token is valid. The tags also include a “Manufacturer” tag that describes a hardware manufacturer of the computing system 108. The tags also include a tag such as “OSVer” that describes a version of the operating system installed on the computing system 108. The tags also include a tag such as “OSName” tag that includes a name of the operating system. The tags also include a “languageID” tag that includes a language identifier for a human-readable language used by the operating system or other applications executed at the computing system 108. The tags also include a “CountryID” tag that identifies a country or region in which the computing system 108 is located.

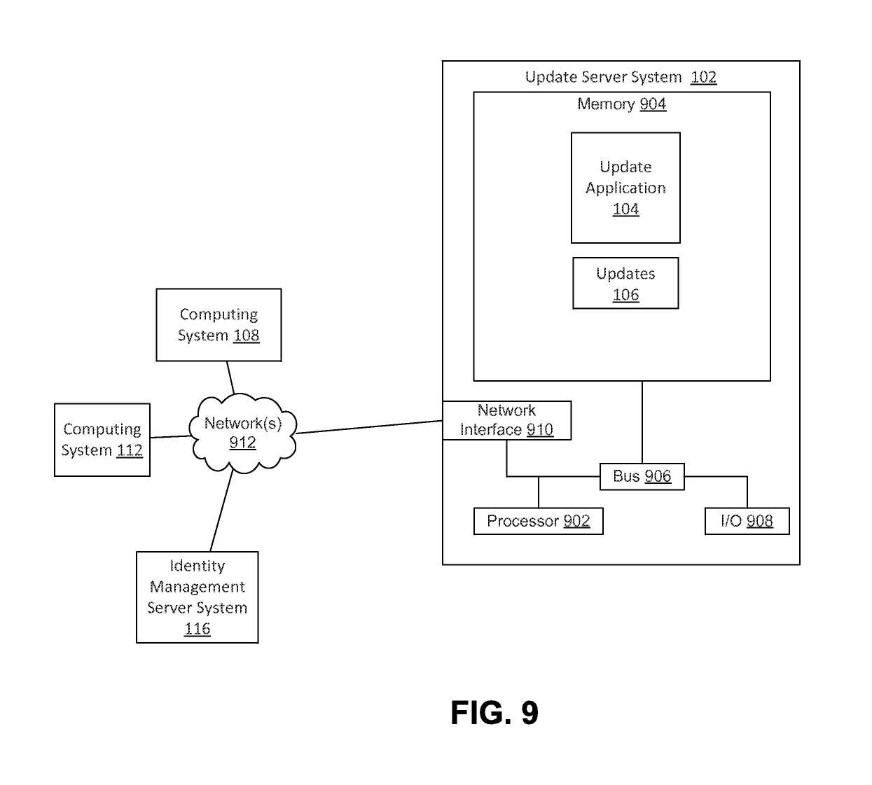

Any suitable computing system or group of computing systems can be used to implement the update server system 102. For example, FIG. 9 is a block diagram depicting an example of an implementation of an update server system 102 according to certain exemplary embodiments.

The update server system 102 can include a processor 902 that is communicatively coupled to a memory 904 and that executes computer-executable program code and/or accesses information stored in the memory 904. The processor 902 may comprise a microprocessor, an application-specific integrated circuit (“ASIC”), a state machine, or other processing device. The processor 902 can include any of a number of processing devices, including one. Such a processor can include or may be in communication with a computer-readable medium storing instructions that, when executed by the processor 902, cause the processor to perform the operations described herein.

The memory 904 can include any suitable computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The update server system 102 may also comprise a number of external or internal devices such as input or output devices. For example, the update server system 102 is shown with an input/output (“I/O”) interface 908 that can receive input from input devices or provide output to output devices. A bus 906 can also be included in the update server system 102. The bus 906 can communicatively couple one or more components of the update server system 102.

The update server system 102 can execute program code that configures the processor 902 to perform one or more of the operations described above with respect to FIGS. 1-5. The program code can include one or more of the update application 104 and the updates 106. The program code may be resident in the memory 904 or any suitable computer-readable medium and may be executed by the processor 902 or any other suitable processor. In some embodiments, the updates 106 can be resident in the memory 904, as depicted in FIG. 9. In other embodiments, the updates 106 can be resident in a memory that is accessible via a data network, such as a memory accessible to a cloud service.

The update server system 102 can also include at least one network interface 910. The network interface 910 can include any device or group of devices suitable for establishing a wired or wireless data connection to one or more data networks 912. Non-limiting examples of the network interface 910 include an Ethernet network adapter, a modem, and/or the like. The update server system 102 can communicate with computing systems 108, 112 and the identity management server system 116.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
receiving, via a data network, first context data and second context data, the first context data describing a first attribute of a first computing system on which a first instance of a client application is installed, the second context data describing a second attribute of a second computing system on which a second instance of the client application is installed, wherein the first and second attributes are independent of the client application;
determining, by a processing device, that an update is to be provided to the first computing system by using the first context data to determine that the update is applicable to the first instance of the client application installed on the first computing system having the first attribute;
providing the update to the first computing system; and
determining, by the processing device, that the update is not to be provided to the second computing system by using the second context data to determine that the update is not applicable to the second instance of the client application installed on the second computing system having the second attribute.

2. The method of claim 1, further comprising at least one of:
providing an additional update to the second computing system based on the processing device determining from the second context data that the additional update is applicable to the second instance of the client application installed on the second computing system having the second attribute; and
notifying the second computing system that no applicable updates are available.

3. The method of claim 1, wherein the first attribute comprises a first hardware attribute of the first computing system and the second attribute comprises a second hardware attribute of the second computing system.

4. The method of claim 1, wherein the first attribute comprises a first programming attribute and the second attribute comprises a second programming attribute.

5. The method of claim 4, wherein the first programming attribute comprises a first operating system executed at the first computing system and the second programming attribute comprises a second operating system executed at the second computing system.

6. The method of claim 4, wherein the first programming attribute comprises a first human-readable language for receiving input or displaying output at the first computing system and the second programming attribute comprises a second human-readable language for receiving input or displaying output at the second computing system.

7. The method of claim 1, further comprising:
prior to receiving the first context data, determining, by the processing device, that a first update description received with the first update includes a first value for the first attribute, wherein the processing device determines from the first context data that the first update modifies the feature associated with the first attribute based on the first context data including the first value for the first attribute; and
prior to receiving the second context data, determining, by the processing device, that a second update description received with the second update includes a second value for the second attribute, wherein the processing device determines from the second context data that at least one of (i) the second update modifies the feature associated with the second attribute based on the second context data including the second value for the second attribute and (ii) the second update does not modify the feature associated with the second attribute based on the second context data including a different value than the second value for the second attribute.

8. The method of claim 1, further comprising:
receiving, via the data network, third context data describing a subscription attribute for a third instance of the client application installed on a third computing system; and
performing at least one of:
providing an additional update for the third instance of the client application to the third computing system based on the processing device determining that the additional update modifies a feature of the client application associated with a paid subscription version of the client application and that the subscription attribute indicates the third instance of the client application is the paid subscription version; and
providing a different update for the third instance of the client application to the third computing system based on the processing device determining that the different update modifies a feature of the client application associated with an unpaid subscription version of the client application and that the subscription attribute indicates the third instance of the client application is the unpaid subscription version.

9. A system comprising:
a processing device; and
a non-transitory computer-readable medium communicatively coupled to the processing device,
wherein the processing device is configured to execute instructions to perform operations comprising:
receiving, via a data network, first context data and second context data, the first context data describing a first attribute of a first computing system on which a first instance of a client application is installed, the second context data describing a second attribute of a second computing system on which a second instance of the client application is installed, wherein the first and second attributes are independent of the client application,
determining that an update is to be provided to the first computing system by using the first context data to determine that the update is applicable to the first instance of the client application installed on the first computing system having the first attribute,
providing the update to the first computing system, and
determining that the update is not to be provided to the second computing system by using the second context data to determine that the update is not applicable to the second instance of the client application installed on the second computing system having the second attribute.

10. The system of claim 9, wherein the first attribute comprises a first hardware attribute of the first computing system and the second attribute comprises a second hardware attribute of the second computing system.

11. The system of claim 9, wherein the first attribute comprises a first programming attribute and the second attribute comprises a second programming attribute.

12. The system of claim 11, wherein the first programming attribute comprises a first operating system executed at the first computing system and the second programming attribute comprises a second operating system executed at the second computing system.

13. The system of claim 11, wherein the first programming attribute comprises a first human-readable language for receiving input or displaying output at the first computing system and the second programming attribute comprises a second human-readable language for receiving input or displaying output at the second computing system.

14. The system of claim 13, wherein the operations further comprise:
prior to receiving the first context data, determining that a first update description received with the first update includes a first value for the first attribute, wherein the processing device is configured to determine from the first context data that the first update modifies the feature associated with the first attribute based on the first context data including the first value for the first attribute; and
prior to receiving the second context data, determining that a second update description received with the second update includes a second value for the second attribute, wherein the processing device is configured to determine from the second context data that at least one of (i) the second update modifies the feature associated with the second attribute based on the second context data including the second value for the second attribute and (ii) the second update does not modify the feature associated with the second attribute based on the second context data including a different value than the second value for the second attribute.

15. A non-transitory computer-readable medium having program code stored thereon, the program code comprising:
program code for receiving, via a data network, first context data and second context data, the first context data describing a first attribute of a first computing system on which a first instance of a client application is installed, the second context data describing a second attribute of a second computing system on which a second instance of the client application is installed, wherein the first and second attributes are independent of the client application;
program code for determining that an update is to be provided to the first computing system by using the first context data to determine that the update is applicable to the first instance of the client application installed on the first computing system having the first attribute;
program code for providing the update to the first computing system; and
program code for determining that the update is not to be provided to the second computing system by using the second context data to determine that the update is not applicable to the second instance of the client application installed on the second computing system having the second attribute.

16. The non-transitory computer-readable medium of claim 15, wherein the first attribute comprises a first hardware attribute of the first computing system and the second attribute comprises a second hardware attribute of the second computing system.

17. The non-transitory computer-readable medium of claim 16, wherein the first attribute comprises a first programming attribute and the second attribute comprises a second programming attribute.

18. The non-transitory computer-readable medium of claim 17, wherein the first programming attribute comprises a first operating system executed at the first computing system and the second programming attribute comprises a second operating system executed at the second computing system.

19. The non-transitory computer-readable medium of claim 17, wherein the first programming attribute comprises a first human-readable language for receiving input or displaying output at the first computing system and the second programming attribute comprises a second human-readable language for receiving input or displaying output at the second computing system.

20. The non-transitory computer-readable medium of claim 15, further comprising:
program code for determining, prior to receiving the first context data, that a first update description received with the first update includes a first value for the first attribute, wherein the first context data is used to determine that the first update modifies the feature associated with the first attribute based on the first context data including the first value for the first attribute; and
program code for determining, prior to receiving the second context data, that a second update description received with the second update includes a second value for the second attribute, wherein the second context data is used to determine that at least one of (i) the second update modifies the feature associated with the second attribute based on the second context data including the second value for the second attribute and (ii) the second update does not modify the feature associated with the second attribute based on the second context data including a different value than the second value for the second attribute.
